(19) United States
(12) Patent Application Publication
(10) Pub. No.: US 2024/0005172 A1
(43) Pub. Date: Jan. 4, 2024

(54) LEARNING SYSTEM AND METHOD

(71) Applicant: KABUSHIKI KAISHA TOSHIBA, Minato-ku (JP)

(72) Inventors: Shuhei NITTA, Tokyo (JP); Ryusuke HIRAI, Tokyo (JP); Yoshiyuki KOKOJIMA, Yokohama Kanagawa (JP)

(73) Assignee: KABUSHIKI KAISHA TOSHIBA, Minato-ku (JP)

(21) Appl. No.: 18/169,598

(22) Filed: Feb. 15, 2023

(30) Foreign Application Priority Data
Jul. 1, 2022 (JP) 2022-107038

(51) Int. Cl. G06N 3/098

(52) U.S. Cl. CPC G06N 3/098

(57) ABSTRACT

According to one embodiment, a learning system includes a plurality of local devices and a server. Each of the local devices includes a processor. The processor selects a mini-batch from local data. The processor trains a local model using the mini-batch. The processor generates local data information relating to the local data included in the mini-batch and indicating information different from a label. The processor transmits a local model parameter relating to the local model and the local data information to the server. The server includes a processor. The processor calculates an integrated parameter using the local data information acquired from each of the local devices. The processor updates a global model using the integrated parameter and the local model parameter acquired from each of the local devices.

### CROSS-REFERENCE TO RELATED APPLICATION

This application is based upon and claims the benefit of priority from Japanese Patent Application No. 2022-107038, filed Jul. 1, 2022, the entire contents of which are incorporated herein by reference.

### FIELD

Embodiments described herein relate to a learning system and method.

### BACKGROUND

A machine learning model (local model) is trained in respective local devices based on respective pieces of training data acquired, and the parameters of the trained local models are sent to a server. In the server, the parameters of the respective local models are integrated to update a machine learning model present in the server (i.e., a global model). The parameters of the updated global model are distributed to each of the local devices. There is a learning method called “federated learning” in which such a series of processing is repeated.

In federated learning, training is performed in a plurality of local devices, thus allowing for deconcentration of the computational load. Furthermore, since only the parameters are exchanged with the server, there is no need to exchange the training data itself. Thus, this is advantageous in that high privacy confidentiality and low communication costs are ensured. However, in each of the local devices belonging to each environment, information based on a small number of important pieces of data, such as abnormal data, is diluted in the stage where the pieces of information are integrated in the server, thus resulting in difficulty in performing training in consideration of such a small number of important pieces of data.

### BRIEF DESCRIPTION OF THE DRAWINGS

FIG. 1 is a conceptual diagram showing a learning system according to the present embodiment.

FIG. 2 is a flowchart showing a learning process of a learning system according to a first embodiment.

FIG. 3 is a flowchart showing a learning process of a learning system according to a second embodiment.

FIG. 4 is a block diagram showing an example of a hardware configuration of a local device and a server.

### DETAILED DESCRIPTION

In general, according to one embodiment, a learning system includes a plurality of local devices and a server. Each of the local devices includes a processor. The processor selects a mini-batch from local data. The processor trains a local model using the mini-batch. The processor generates local data information relating to the local data included in the mini-batch and indicating information different from a label. The processor transmits a local model parameter relating to the local model and the local data information to the server. The server includes a processor. The processor calculates an integrated parameter using the local data information acquired from each of the local devices. The processor updates a global model using the integrated parameter and the local model parameter acquired from each of the local devices.

Hereinafter, a learning system and method according to the present embodiment will be described in detail with reference to the drawings. In the embodiment described below, elements assigned the same reference numeral perform the same operation, and repeat descriptions will be omitted as appropriate.

### First Embodiment

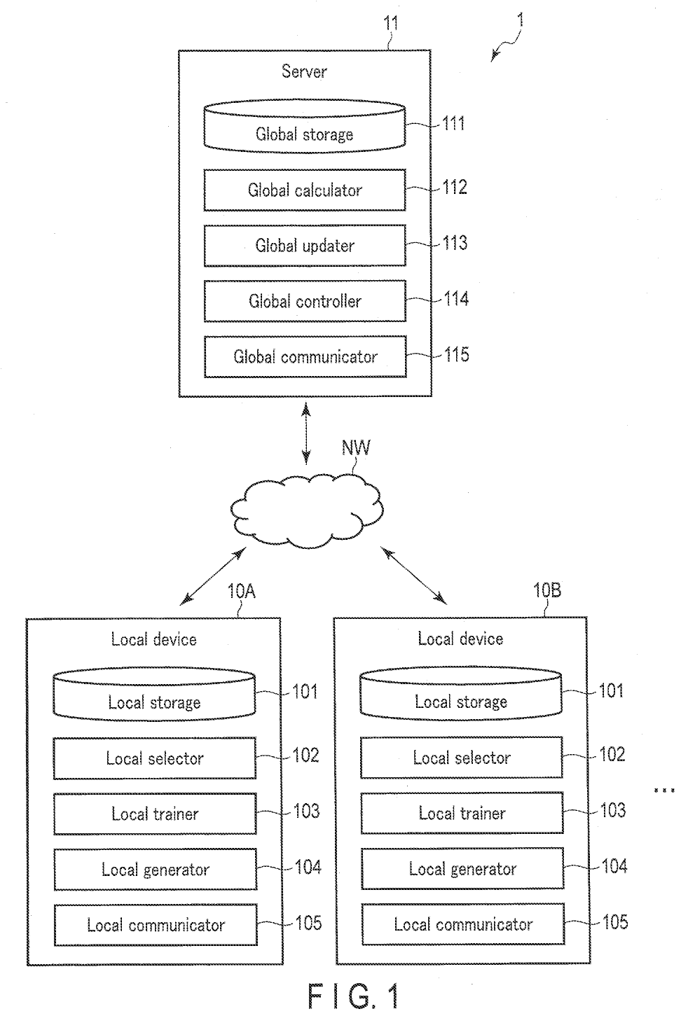

A learning system according to a first embodiment will be described with reference to the block diagram shown in FIG. 1.

The learning system according to the first embodiment includes a local device 10A, a local device 10B, and a server 11, which are connected to each other via a network NW so as to be able to transmit and receive data. Although two local devices, the local device 10A and the local device 10B, are shown as an example herein, three or more local devices 10 may be included. Also, in a description that applies to all of the local devices, the local devices are simply referred to as a “local device 10”.

Each of the local devices 10 includes a local storage 101, a local selector 102, a local trainer 103, a local generator 104, and a local communicator 105.

The local storage 101 stores local data, which is training data, a local label attached to the local data, an attribute label, and a local model.

In the present embodiment, the local data assumes an examination image of an article manufactured in a factory. If the local data is an examination image, for example, the local label is a category classification of a defect (a scratch, smudge, deformation, etc.) attached to the examination image. The attribute label is information associated with the local data and different from the local label. For example, it is a degree of importance of an event individually attached to the local data. For example, the attribute label is a label to which information regarding a non-defective product with particularly excellent performance among manufactured products or a defective product with no excellent performance is attached.

The local model is, for example, a neural network, and is trained so as to be able to execute a classification task of classifying the products on the examination image into a non-defective product and a defective product. The task of the local model is not limited to the classification task, and may be any task such as object detection, semantic segmentation, action recognition, abnormality detection, suspicious-person detection, regression, prediction, etc. The training data and input data for executing the trained local model are not limited to an image, and may be time-series data such as a voice, an operating sound such as a sound of a machine, an environmental sound, acceleration data, and instrumental data, or any data, provided it can be handled in machine learning.

The local selector 102 selects a mini-batch from the local data. For example, a mini-batch may be selected from the local data through random sampling.

The local trainer 103 updates the local model by training the local model using the mini-batch.

The local generator 104 generates local data information relating to the local data included in the mini-batch and indicating information different from a label. The local data information is, for example, information representing the characteristics of the local data included in the mini-batch used to update the local model. The local generator 104 may generate information regarding the label of the local data such as a frequency distribution of the label, instead of the local data information.

The local communicator 105 transmits a local model parameter and the local data information regarding the local model to the server 11. The local model parameter is a set of parameters (such as a weight coefficient and a bias) of the neural network for sharing a parameter with a global model. The local communicator 105 receives the global model from the server 11.

The server 11 includes a global storage 111, a global calculator 112, a global updater 113, a global controller 114, and a global communicator 115.

The global storage 111 stores the global model and the local data information. The global model is, for example, a neural network model.

The global calculator 112 calculates an integrated parameter using the local data information received from the local devices 10.

The global updater 113 updates the global model using the local model parameter and the local data received from the local devices 10.

The global controller 114 controls the operation of the server 11 in addition to performing control to store history data of the local data information in the global storage 111.

The global communicator 115 receives each of the local model parameters and the local data information from the local devices 10. The global communicator 115 transmits the updated global model to each of the local devices 10.

Examples of the local model and the global model include a convolutional neural network (CNN), a multi-layer perceptron (MLP), a recurrent neural network (RNN), a transformer, and a bidirectional encoder representations from transformer (BERT), and may be other neural networks used in general machine learning. Also, the embodiment is applicable to not only the neural network model but also all machine-trained models to which federated learning can be applied. For example, the embodiment may be applied to models such as a support vector machine (SVM) and a random forest.

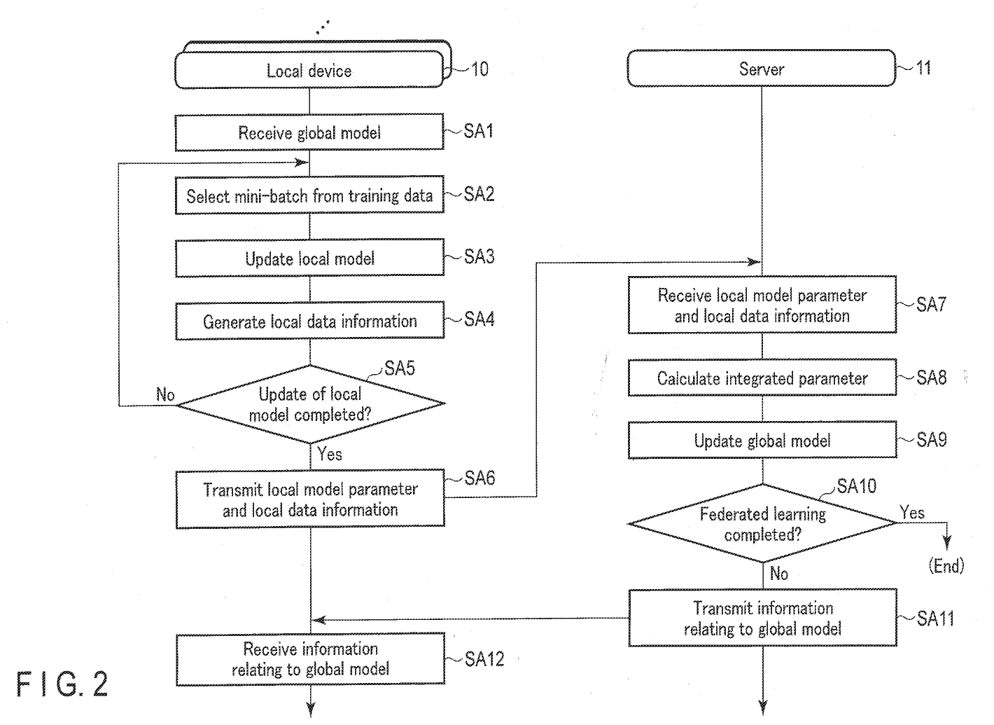

Next, a learning process of the learning system 1 according to the first embodiment will be described with reference to the sequence diagram shown in FIG. 2. Each of the local devices 10 performs a process in line with the sequence diagram, unless explained otherwise.

In step SA1, the local communicator 105 of the local device 10 receives a global model from the server 11. The global model is, for example, a set of parameters of a neural network shared by the local devices 10. At the start of training, a randomly initialized value or a value obtained through pre-training using an open data set is used for the parameters.

In step SA2, the local selector 102 of the local device 10 selects a mini-batch. In this step, the local selector 102 selects a subset from local data through random sampling and selects, as a mini-batch, a local label and an attribute label attached to the data selected as the subset.

In step SA3, the local trainer 103 of the local device 10 updates a local model by training the local model using the mini-batch. Specifically, an input image input to the local model is set to x→ᵢⱼ (i=1, 2, 3, . . . , j=1, . . . , Nᵢ). Herein, the superscript arrow indicates that target data to which an arrow is attached is tensor data. i denotes serial numbers that identify the local devices 10, j denotes serial numbers of the training data, and Nᵢ is a natural number of two or greater, which represents the number of pieces of training data sampled in the i-th local device 10. The input image x→ᵢⱼ is a set of pixels with a horizontal width W and a vertical width H, and is two-dimensional tensor data.

A target label for the input image x→ᵢⱼ is represented by t-ij. The target label t-ij is an M-dimensional vector with an element of concern being 1 and other elements being 0. M denotes the number of classification types and is a natural number of two or greater.

If the input to the local model is indicated by the input image x→ᵢⱼ and the output from the local model is indicated by y→ᵢⱼ, they may be represented by the following formula (1):

y→ᵢⱼ=f(x→ᵢⱼ) (1)

Herein, f( ) denotes a function of the neural network relating to the local model.

A training error Lᵢⱼ is represented by the following formula (2):

Lᵢⱼ=−t→ᵢⱼ^{T} ln(y→ᵢⱼ) (2)

Herein, the training error Lᵢⱼ is calculated using cross entropy. In each of the local devices 10, the local trainer 103 calculates, as a loss, an average of the training errors of the multiple input images relating to the mini-batch, for example, and updates the parameters of the neural network relating to the local model using back propagation and stochastic gradient descent, for example, so as to minimize the loss.

When updating the local model, a personalization method for each local device 10, such as introduction of an individualized layer, meta learning, or distillation, may be adopted in order to absorb a difference in the data distribution (data features) between the local devices 10. For example, the input layer of each local model may be set as a layer having a parameter unique to each local model, or a part of an intermediate layer may be set as a layer having a parameter unique to each local model. If a normalized layer is included in each local model, the normalized layer may be set as a layer having a parameter unique to each local model.

In this manner, instead of copying the received global model directly to the local model, the global model may be converted according to the personalization method to update the local model.

In step SA4, the local generator 104 of the local device 10 generates local data information from the selected mini-batch. The local data information herein includes at least any one of the following: a frequency distribution of the attribute label relating to the local data included in the mini-batch; a frequency distribution of the loss for the local model; a frequency distribution of the loss for the global model; and a statistical value. For example, an average value, a maximum value, or a median value may be used as the statistical value.

In step SA5, the local trainer 103 of the local device 10 determines whether or not training of the local model is completed. For example, a determination that training is completed may be made if a parameter is updated a predetermined number of times, or a determination that training is completed may be made if an absolute value of an update amount of a parameter or a sum of the absolute values reaches a certain value. The determination of whether or not training is completed is not limited to the above-described example; termination conditions generally adopted in machine learning may be adopted. If training is completed, the process proceeds to step SA6; and if training is not completed, the process returns to step SA2, and the same process is repeated.

In step SA6, the local communicator 105 of the local device 10 transmits, to the server 11, the local parameter and the local data information relating to the local model for which training is completed. For example, the local model parameter may be a value of a parameter after being updated, or an amount of change caused by the update such as a difference between a value of a parameter before being updated and a value of a parameter after being updated. The local communicator 105 may also compress data relating to a parameter set to be transmitted to the server 11 and then transmit the data. The processing of compressing data may be lossless compression or lossy compression. Compressing data to transmit it can save the communication volume and the communication band. The data may also be encrypted to be transmitted, whereby the confidentiality of the data can be enhanced.

In step SA7, the global communicator 115 of the server 11 receives the local model parameters and the local data information from the respective local devices 10.

In step SA8, the global calculator 112 of the server 11 generates an integrated parameter based on the received local data information of the respective local devices 10. As the integrated parameter, for example, a weight of each local model parameter for performing an update by subjecting the local model parameters to weighted-averaging may be calculated. For example, if the local data information is an attribute label and is a maximum value or a total value of the degree of importance attached to each of the local data in the mini-batch, a value proportional to these values may be calculated as the integrated parameter.

Also, if the information on a frequency distribution of the local label is received instead of the local data information, an integrated parameter is calculated so that the result of the product sum of the integrated parameter and the frequency distribution will be uniform. Specifically, if the first local device 10 performs an update using ten pieces of non-defective product sample data and the second local device 10 performs an update using five pieces of defective product sample data, an integrated parameter is calculated by averaging the local model parameters with the local model parameter of the first local device 10 set as onefold and the local model parameter of the second local device 10 set as twofold. Thus, it is possible to avoid the consequence of a recognition rate of a local label having a low appearance frequency being hard to take into consideration. A target frequency distribution may not be uniform but may be designed so as to follow a predetermined preexisting distribution.

In this manner, it is possible to implement a model update while taking into consideration even a small number of important pieces of local data. Also, by calculating, as an integrated parameter, a value proportional to a statistical value of a loss for the local model or the global model, it is possible to increase the influence of the parameters of the local model trained in a state where many pieces of local data that are hard to recognize are included, and it is possible to expect the effect that the training of the global model and the local model can be terminated early.

In step SA9, the global updater 113 of the server 11 updates the global model based on the integrated parameter. The updating of the global model may be implemented by replacing a parameter with a value obtained by subjecting the local model parameters of the respective local devices to weighted-averaging using the integrated parameter; or the updating of the global model may be implemented using a moving average of the weighted average value and the global model before being updated.

In step SA10, the global updater 113 of the server 11 determines whether or not the federated learning is completed. A determination that the federated learning is completed may be made, for example, if the performance of the local model such as the recognition, accuracy, precision, and recall of the local model of each local device 10 achieves a target value, if the global model is updated a predetermined number of times, or if the update range of the global model converges to a threshold or below. If the federated learning is completed, the training process is terminated; and if the federated learning is not completed, the process proceeds to step SA11.

In step SA11, the global communicator 115 of the server 11 transmits information regarding the global model to each local device 10. The information regarding the global model is, for example, at least any one of the following: the global model body; a parameter value obtained after the update; and an amount of change caused by the update.

In step SA12, the local communicator 105 of the local device 10 receives the information regarding the global model from the server 11. Subsequently, the process from step SA2 to step SA1l may be repeatedly performed until the federated learning is completed.

According to the first embodiment described above, when performing federated learning, the local device calculates local data information regarding a mini-batch, and the server updates the global model in consideration of the local data information. Thus, even a small number of important pieces of data can increase the degree of influence on the training performed on the model, allowing implementation of federated learning which takes into consideration the data that is important regardless of the data quantity.

### Second Embodiment

In the first embodiment, since the global model is updated by the local model parameters transmitted unilaterally from the local devices, the bias of the information is not controlled. The second embodiment differs from the first embodiment in that selection request information regarding a request for selected information is transmitted from the server to each local device.

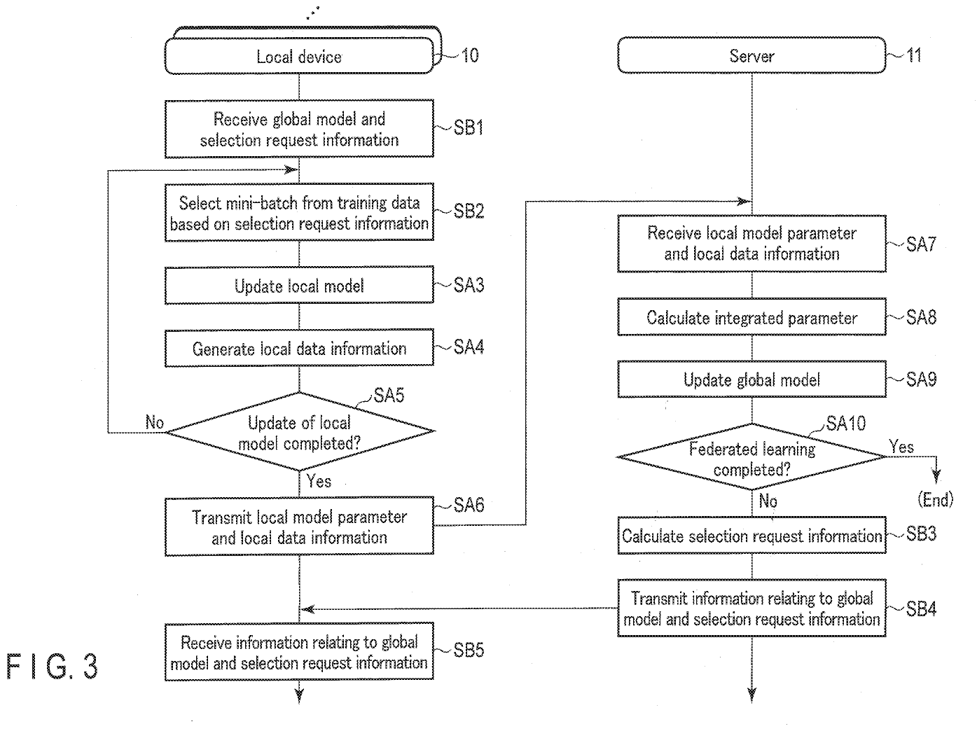

A training process of a learning system according to the second embodiment will be described with reference to the flowchart shown in FIG. 3.

Since the processes (step SA3 through step SA10) performed by the local device 10 are the same as that of the first embodiment, descriptions thereof will be omitted.

In step SB1, the local communicator 105 of the local device 10 receives a global model and selection request information. The selection request information is information for controlling local data information. For example, if the local data information is a frequency distribution of the local label in the mini-batch, and the local label is information regarding non-defective products and defective products, the selection request information is considered to be a mix ratio of a non-defective product and a defective product, a specific mix ratio of defective types, and the like. The selection request information represents a set of mini-batches used in the past, and may be an index of the number of times of communication performed between the server 11 and the local device 10, that is, an index of the number of times of exchange of the parameters relating to the updating of the model.

In step SB2, the local selector 102 of the local device 10 selects a mini-batch from training data based on the selection request information. Specifically, if the selection request information is a frequency distribution of the local label in the mini-batch, the local selector 102 selects a subset of the training data as a mini-batch so that it will be the same as the label distribution indicated by the selection request information. Also, if the selection request information is an index of the number of times of communication, the local selector 102 may select relevant training data.

In step SB3, the global controller 114 of the server 11 calculates selection request information for each local device 10 for the next update. For example, if the received local data information includes a frequency distribution of the local label, and if the frequency distribution is biased and the information needed by the server 11 is missing, the server 11 may not be able to calculate an integrated parameter that can generate a target frequency distribution. In such a case, by calculating a target frequency distribution as selection request information, the global controller 114 can cause the local device 10 to select a mini-batch of the local data that can generate the target frequency distribution. With regard to the direction of training to be performed for the next update, if a frequency distribution of the local label is included, for example, a local label with a small data amount can be determined from the local data information stored in the global storage 111. Therefore, selection request information that includes an instruction to include a desired local label in a mini-batch may be generated.

In step SB4, the global communicator 115 of the server 11 transmits information regarding the global model and the selection request information to each local device 10.

In step SB5, the local communicator 105 of the local device 10 receives the information regarding the global model and the selection request information. Subsequently, the processing of step SB1, step SB2, step SA3 through step SA10, step SB3, and step SB4 may be repeatedly performed until the federated learning is completed.

The global controller 114 of the server 11 may determine whether or not the local data information transmitted from the local device 10 satisfies the request after transmitting the selection request information to the local device 10. For example, if the local data information transmitted from the local device 10 differs from the selection request information, such as a difference between the frequency distribution of the selection request information and the frequency distribution of the local data information being equal to or above a threshold, the weights of the local model parameters from the local device 10 may be reduced to generate an integrated parameter. This enables the server 11 to properly control the directionality of the training of the model (the directionality of the model update) based on the selection request information.

According to the second embodiment described above, it is not only possible to realize federated learning which takes into consideration the data that is important regardless of the data quantity but also possible to perform federated learning effectively since it is possible to control the directionality of the model update which causes the local device to train the local model in mini-batches that include a desired data type.

In the above-described embodiments, the local data assumes an examination image of a factory and assumes a classification task of identifying non-defective products and defective products; however, the local data is not limited thereto. The local data may assume a handprinted character image, and a task of an optical character recognition (OCR) which outputs a text from the handprinted character image through character recognition may be performed. In this case, the local data information may include type-related information such as a type of field (e.g., a postal code that is relatively easy to recognize, an address or a free description that is relatively difficult to recognize, etc.), or include information regarding a flag indicating whether or not a result of character recognition performed with a general machine-trained model indicates an instance of a user's revision.

The local data may merely be document data, in which case the local data information may include flag information such as a degree of importance associated with the document, a key word associated with the document, etc.

The local data may be data relating to medical care, such as a medical image. The local model may be a model which inputs the data relating to medical care and outputs an image processing result and an image recognition result. In this case, the local data information may include, for example, device information indicating the performance of a model such as whether the model is a high-end model or a low-end model, information indicating a discrepancy between imaging findings and a biopsy, information on a prognosis, etc.

The local data may be product sales data such as customer data and product purchase data. The local model may be a model which inputs sales data and outputs information on the recommendation of a product or a service, information on a forecast, etc. In this case, the local data information may include attribute information such as a season, an area, and an age group in/by which the product was purchased.

The local data may be moving image data recorded by a drive recorder. The local model may be a model which inputs a moving image captured by a camera and information on the acceleration of an automobile body acquired by an acceleration sensor and outputs a result of the judgment of an accident. In this case, the local data information may include information such as an age group of a driver, a driving period, an amount of money covered by insurance, remaining points of a license, a place, and a time zone.

The local data may be a camera image of robot picking. In this case, the local data information may include information regarding the past probability of success in picking, a weight of a target product, a size, a price, fragility, the number of items in stock, etc.

The local data may be a camera image of automated driving of a vehicle and sensor data. In this case, the local data information may include information regarding an occurrence rate of accidents in a traveling position, a traveling period (such as a season and a time zone), weather, road surface information, the number of lanes, the number of vehicles, a latitude/longitude/altitude, etc.

The local data may be video data of a surveillance camera. In this case, the local data information may include information regarding a period of time, weather, and in the case of a surveillance camera installed in a store, etc., a degree of congestion, sales data, and the presence or absence of an event.

The local data may be data of access to a website or an application through a personal computer or a smartphone. In this case, the local data information may include information regarding the number of views, a view history, and in the case of a website or an application which replays a moving image, the number of replays, a replay history, an age group, an access time zone, a period of time, world affairs, etc.

The embodiments described above assume the case where the local model of the local device 10 and the global model of the server 11 are neural networks having basically the same structure; however, each of the local models of the local devices 10 may be a scalable neural network that shares some of the parameters with the neural network of the global model. The scalable neural network is a neural network that can adjust the model size such as the number of convolutional layers of the network model according to the required amount of computation or performance. For example, in each of the local devices 10, the local models being different indicates that the model structure and the number of parameters, such as the model size, the weight coefficient, the bias, etc., are different. In the server 11, the parameters of the global model may be updated, and a part of the global model may be transmitted to each of the local devices 10 according to the size of the local models. The global controller 114 of the server 11 may transmit selection request information including information about how much computational complexity is required to train the local model in the local devices 10. On the other hand, the local generator 104 of the local device 10 may generate local data information based on the computational costs required in training, and the local communicator 105 may transmit the local data information to the server 11.

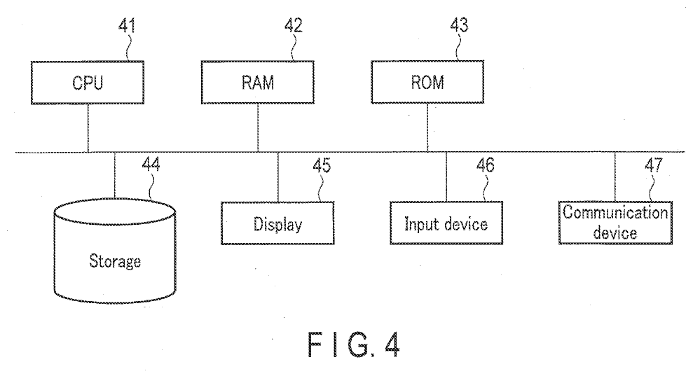

Herein, an example of a hardware configuration of the local device 10 and the server 11 according to the above-described embodiments is shown with reference to the block diagram of FIG. 4.

The local device 10 and the server 11 include a central processing unit (CPU) 41, a random access memory (RAM) 42, a read only memory (ROM) 43, a storage 44, a display 45, an input device 46, and a communication device 47, which are connected to one another via a bus.

The CPU 41 is a processor that executes arithmetic processing and control processing according to one or more programs. The CPU 41 uses a prescribed area in the RAM 42 as a work area to perform the processing of each component of the local device 10 and the server 11 described above in cooperation with one or more programs stored in the ROM 43, the storage 44, etc.

The RAM 42 is a memory such as a synchronous dynamic random access memory (SDRAM). The RAM 42 functions as a work area of the CPU 41. The ROM 43 is a memory that stores programs and various types of information in a manner that does not permit rewriting.

The storage 44 is a device that writes and reads data to and from a magnetic recording medium, such as a hard disk drive (HDD), a semiconductor storage medium, such as a flash memory, or an optically recordable storage medium. The storage 44 writes and reads data to and from a storage medium under the control of the CPU 41.

The display 45 is a display device such as a liquid crystal display (LCD). The display 45 displays various types of information based on a display signal from the CPU 41.

The input device 46 is an input device such as a mouse and a keyboard. The input device 46 receives information input by the user as an instruction signal, and outputs the instruction signal to the CPU 41.

The communication device 47 communicates with external devices via a network under the control of the CPU 41.

The instructions indicated in the process steps described in the above embodiments can be implemented based on a software program. It is also possible to achieve the same effects as those provided by the control operation executed by the learning system (local device and server) described above by having a general-purpose computer system store the program in advance and read the program. The instructions described in the above embodiments are stored, as a program executable by a computer, in a magnetic disk (flexible disk, hard disk, etc.), an optical disk (CD-ROM, CD-R, CD-RW, DVD-ROM, DVD±R, DVD±RW, Blu-ray (registered trademark) disk, etc.), a semiconductor memory, or a similar storage medium. The storage medium here may utilize any storage technique provided that the storage medium can be read by a computer or by a built-in system. The computer can implement the same operation as the control operation performed by the learning system (local device and server) according to the above embodiments by reading the program from the storage medium and causing, based on the program, the CPU to execute the instructions described in the program. The computer may, of course, acquire or read the program through a network.

Also, an operating system (OS) working on a computer, database management software, middleware (MW) of a network, etc., may execute a part of the processing for realizing the embodiments based on the instructions of a program installed from a storage medium onto a computer and a built-in system.

Furthermore, the storage medium according to the embodiments is not limited to a medium independent from a computer or a built-in system, and may include a storage medium storing or temporarily storing a program downloaded through a LAN or the Internet, etc.

In addition, the number of storage media is not limited to one. The embodiments include the case where the process is executed using a plurality of storage media, and the storage media can take any configuration.

The computer or built-in system in the embodiments are used to execute each process in the embodiments, based on a program stored in a storage medium, and the computer or built-in system may be an apparatus consisting of a PC, a microcomputer or the like, or may be a system or the like in which a plurality of apparatuses are connected through a network.

The computer adopted in the embodiments is not limited to a PC; it may be a calculation processing apparatus, a microcomputer, or the like included in an information processor, and a device and apparatus that can realize the functions of the embodiments by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning system comprising a plurality of local devices and a server,
each of the local devices comprising a processor configured to:
select a mini-batch from local data;
train a local model using the mini-batch;
generate local data information relating to the local data included in the mini-batch and indicating information different from a label; and
transmit a local model parameter relating to the local model and the local data information to the server,
the server comprising a processor configured to:
calculate an integrated parameter using the local data information acquired from each of the local devices; and
update a global model using the integrated parameter and the local model parameter acquired from each of the local devices.

2. The system according to claim 1, wherein the local data information is at least one of a frequency distribution of a loss for the local model, a frequency distribution of a loss for the global model, a statistical value, or a frequency distribution of attribute information relating to the local data included in the mini-batch.

3. The system according to claim 1, wherein the processor of the server generates the integrated parameter by performing weighted-averaging of the local model parameters based on the local data information.

4. The system according to claim 1, wherein the processor of the server is further configured to:
generate selection request information for controlling a direction that training of the local model will take based on a history of the local data information; and
transmit the selection request information to the plurality of local devices.

5. The system according to claim 4, wherein, in each of the local devices, the processor of the local device selects a mini-batch based on the selection request information.

6. The system according to claim 1, wherein
the local model is a scalable neural network capable of adjusting a computing cost,
the processor of the local device trains the local model, and
the processor of the local device calculates the local data information based on a computing cost required for training.

7. The system according to claim 6, wherein
the processor of the server is further configured to transmit request information relating to the computing cost to a predetermined local device, and
a processor of the predetermined local device trains the local model based on the request information.

8. A learning method relating to a learning system,
the learning system comprising a plurality of local devices and a server,
the learning method comprising:
at each of the plurality of local devices,
selecting a mini-batch from local data;
updating a local model using the mini-batch;
generating local data information relating to the local data included in the mini-batch and indicating information different from a label; and
transmitting a local model parameter relating to the local model and the local data information to the server,
at the server,
calculating an integrated parameter using the local data information acquired from each of the local devices; and
updating a global model using the local model parameter and the integrated parameter acquired from each of the local devices.

9. The method according to claim 8, wherein the local data information is at least one of a frequency distribution of a loss for the local model, a frequency distribution of a loss for the global model, a statistical value, or a frequency distribution of attribute information relating to the local data included in the mini-batch.

10. The method according to claim 8, further comprising, at the processor, generating the integrated parameter by performing weighted-averaging of the local model parameters based on the local data information.

11. The method according to claim 8, further comprising:
at the sever,
generating selection request information for controlling a direction that training of the local model will take based on a history of the local data information; and
transmitting the selection request information to the plurality of local devices.

12. The method according to claim 11, further comprising, in each of the local devices, selecting a mini-batch based on the selection request information.

13. The method according to claim 8, wherein
the local model is a scalable neural network capable of adjusting a computing cost,
the method further comprising:
at the local device,
training the local model; and
calculating the local data information based on a computing cost required for training.

14. The learning method according to claim 13, further comprising:
at the server, transmitting request information relating to the computing cost to a predetermined local device, and
at the predetermined local device, training the local model based on the request information.
